(19) United States
(12) Patent Application Publication
(10) Pub. No.: US 2022/0219356 A1
(43) Pub. Date: Jul. 14, 2022

(54) COMPRESSION MOLDING UTILIZING AN ELASTOMERIC COMPRESSION TOOL

(71) Applicant: Becklin Holdings, Inc., Grants Pass, OR (US)

(72) Inventor: Jacob William Miller, Medford, OR (US)

(21) Appl. No.: 17/147,451

(22) Filed: Jan. 12, 2021

(51) Int. Cl. B29C 43/18; B33Y 80/00; B29C 33/38; B29B 11/06; B29C 43/36

(52) U.S. Cl. CPC B29C 43/18; B33Y 80/00; B33Y 10/00; B29B 11/06; B29C 43/36; B29C 33/3842

(57) ABSTRACT

Embodiments are directed toward compression molding a polymeric product. The method preferably includes creating a casting mold. Elastomeric material is preferably placed in the casting mold. The elastomeric material is preferably allowed to at least partially cure in the casting mold to define a plug body. The plug body is preferably removed from the casting mold. A female compression mold is preferably provided. Polymeric material is preferably placed in the female compression mold. The polymeric material is preferably compressed in the female compression mold with the plug body to compression mold a polymeric product.

### FIELD OF THE INVENTION

The invention relates to compression molding and, more particularly, to compression molding manufacturing polymeric or composite products with an elastomeric compression plug.

### BACKGROUND OF THE INVENTION

Compression molding polymeric or composite products generally involves placing reinforcement fabric and resin into an optionally heated mold cavity of a female mold and inserting a male plug into the cavity to compress the material or resin into a product that conforms to the shape of the female mold and the male plug. The product is removed from the mold and plug after pressure is released, and resin flash around the edges of the product is typically removed.

Historically, the female mold was made first, and a rubber compression plug was subsequently hand-made to match the inner shape of the female mold. The rubber plug included two-inch-thick slabs of rubber that were glued together and clamped until the glue dried. The plug was then inserted into the female mold, compared to the shape of the female mold, ground down in certain areas as necessary to match the female mold, inserted into the female mold, compared to the shape of the female mold, ground down in certain areas as necessary to match the female mold and so on until the male plug matched the shape of the inner surface of the female mold, minus a determined offset. The compression plug was then pressed while under heat in attempt to cure the rubber to the glue. Accordingly, products manufactured using the hand-ground plug lacked precision, symmetry and consistency. The complexity of manufactured product shapes was also severely limited. Moreover, making the plug was highly time consuming. The rubber also becomes brittle over time (often increasing to two or three times its original hardness), causing the glued seams to break apart and rendering the plug ineffective. The shaping process done via grinding burns the rubber and aerosolizes the rubber, both of which pose health concerns. For these reasons, the industry of compression-molding polymeric or composite products rarely utilized rubber plugs and primarily focused on match-metal mold setups.

In match-metal compression molding, the female mold and the male plug are metallic and shaped to match the desired shape of the product to be manufactured. Metal plug tools have high durability and can be made with shapes that have increased complexity compared to hand-made rubber plugs. Even with these characteristics, compression molding of polymeric or composite products with metal plug generally presents challenges in controlling flashing and limits complexity of products because of the limited flow of material within the cavity. Examples of such limitations in product complexity include a requirement for parts to have drafted faces along the upright walls of the plug and molded parts and to have fixed laminate thickness based on the originally designed tool offset. Undercuts must also be avoided to facilitate removal of the product from the mold and plug.

It would be an advancement in the art to provide a compression molding process that facilitates increased control of flow of the material or resin in the mold and allows some variation in material thickness when manufacturing polymeric or composite products.

### SUMMARY OF THE INVENTION

In one aspect of the invention, an improved compression molding process is described that includes creating (for example, machining) a casting mold. Elastomeric material is placed in the casting mold. The elastomeric material is preferably allowed to at least partially cure in the casting mold to define a plug body. The plug body is preferably defined by the casting mold. Polymeric material is preferably placed in a female compression mold. The polymeric material is preferably compressed in the female compression mold with the plug body to compression mold a polymeric product.

In certain embodiments, the process includes suspending a plug core in the casting mold before the elastomeric material cures. The plug core is preferably coupled to a press. Compressing the polymeric material in the female compression mold with the plug body preferably includes compressing the polymeric material under a force applied by the press through the plug body.

In alternative embodiments, the plug body has a first surface that contacts a second surface of the polymeric product when compressing the polymeric material. A shape of the first surface before compressing the polymeric material is preferably different than or mismatched with respect to a shape of the second surface of the polymeric product after compressing the polymeric material. In some embodiments, the plug body has a shape that is configured to move polymeric material out of the compression mold. In further embodiments, the plug body has a shape that is configured to prevent polymeric material from flowing beyond a flash region in the mold.

In yet further alternative embodiments, the plug body has drafted upright walls, and the female compression mold has non-drafted upright walls. In some embodiments, the plug body is configured to apply pressure to non-drafted upright walls in the female compression mold.

In certain embodiments, the plug body has a shore hardness between approximately 55 A and 75 A. The plug body preferably has a shore hardness of approximately 60 A.

In some embodiments, the polymeric material is a composite material, and the polymeric product is a composite product.

In certain embodiments, the elastomeric material includes platinum-cure silicone.

In some embodiments, creating the casting mold includes programming a numeric control or computer numeric control (“CNC”) machining tool to machine the casting mold. In alternative embodiments, creating the casting mold includes printing the casting mold with a 3D printer.

In another aspect of the invention, an improved system for compression molding a polymeric product is provided. The system preferably includes a cast elastomeric plug body, which in some embodiments, is coupled to a plug core. The elastomeric plug body is preferably resiliently deformable between a non-compressed state and a compressed state. The elastomeric plug body preferably has a first surface that contacts a second surface of the polymeric product when compression molding the polymeric product. A shape of the first surface in the non-compressed state is preferably different than a shape of the second surface after compression-molding the polymeric product.

In certain embodiments, the plug body is configured to apply pressure to non-drafted upright walls of the polymeric product when compression molding the polymeric product. In some embodiments, the system includes a female compression mold, and the plug body has drafted upright walls, whereas the female compression mold has non-drafted upright walls.

### BRIEF DESCRIPTION OF THE DRAWINGS

Preferred and alternative examples of the present invention are described in detail below with reference to the following drawings.

FIG. 1 is an isometric view of a system for casting a plug, including a hanger and a mold.

FIG. 2 is a side elevational view of the hanger of FIG. 1.

FIG. 3 is an isometric view of the hanger of FIG. 1 in the mold of FIG. 1.

FIG. 4 is an isometric view of the hanger of FIG. 1 in the mold of FIG. 1 with one wall removed.

FIG. 5 is an isometric view of a compression plug made using the system of FIG. 1.

FIG. 6 is an isometric view of a system for compression molding a product, including the elastomeric plug of FIG. 5 and a mold.

FIG. 7 is an isometric view of the system of FIG. 6.

FIG. 8 is a cross-sectional view of the system of FIG. 6 taken along line 8-8 in FIG. 7.

FIG. 9 is a cross-sectional view of the system of FIG. 6 taken along line 9-9 in FIG. 7.

FIG. 10 is an isometric view of a portion of another embodiment of a system for compression molding a product.

FIG. 11 is an isometric view of the portion of the system of FIG. 10.

### DETAILED DESCRIPTION OF THE PREFERRED EMBODIMENT

A method and systems for compression molding in accordance with the invention are generally shown in the various figures of the attached drawings wherein numbered elements in the figures correspond to like numbered elements herein.

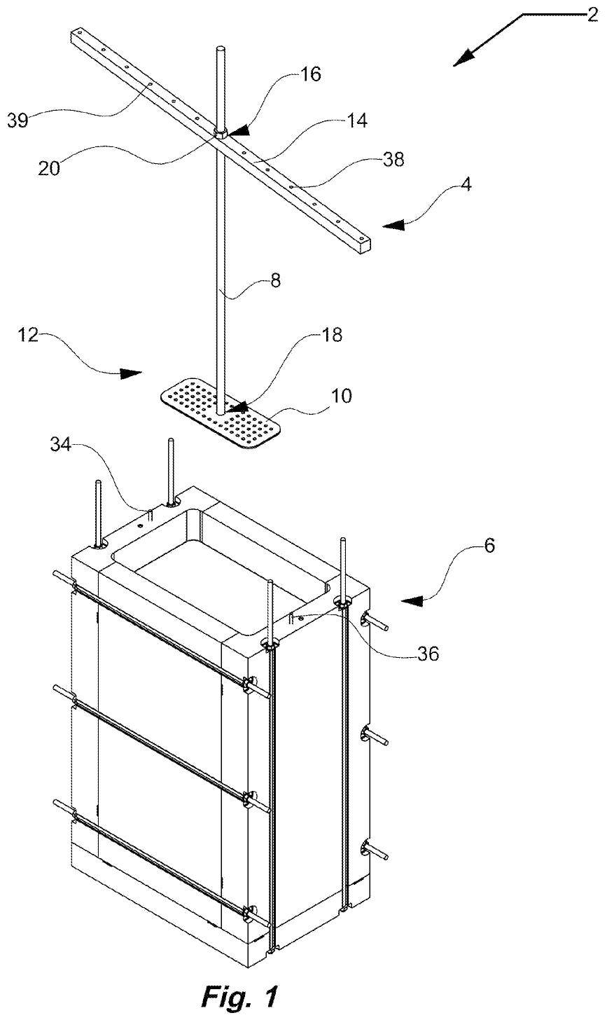

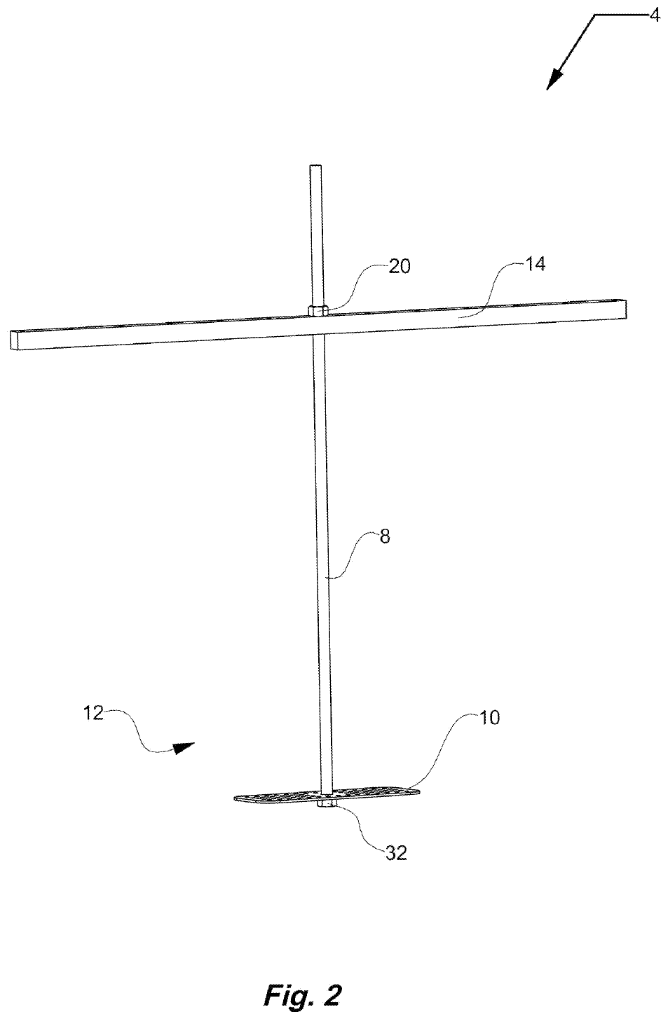

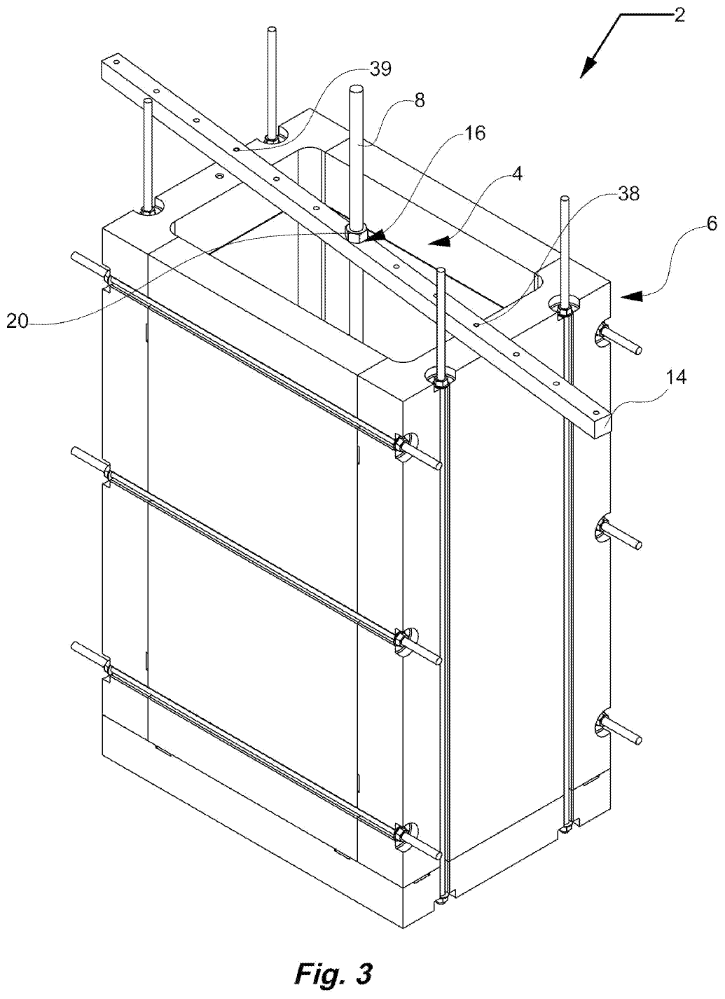

FIG. 1 shows a system 2 for casting a plug, including a hanger 4 and a mold 6. The hanger 4 preferably has a vertical member 8, such as a rod, and optionally a horizontal member 10, such as a plate, that define a plug core 12. The hanger 4 preferably has a suspension member 14, such as a beam, that is configured to suspend the plug core 12 in the mold 6. The suspension member 14 and the horizontal member 10 preferably define openings 16, 18 that are configured to receive the vertical member 8. The hanger 4 preferably has a suspender 20, such as a flange or a nut, that is configured to temporarily suspend the plug core 12 from the suspension member 14. For example, the vertical member 8 may include a threaded or at least partially threaded rod, and the nut may be threaded onto the rod to prevent the rod from being pulled under the force of gravity through the opening 16 beyond the position of the nut. As shown in FIG. 2, some versions of the hanger 4 include a support 32, such as a nut, that is configured to maintain the horizontal member 10 at a given position along the vertical member 8 under the force of gravity. In other versions, the horizontal member 10 is welded or adhered to the vertical member 8. Some compression plugs in accordance with the present invention may be so large as to benefit from multiple vertical members or multiple horizontal members to assist with lifting the plug or mounting it to a press. Accordingly, as shown in FIG. 3, the hanger 4 is preferably lowered into the mold 6 with the plug core 12 suspended from the suspension member 14, which preferably rests on the mold 6 (but in other embodiments rests on a separate structure).

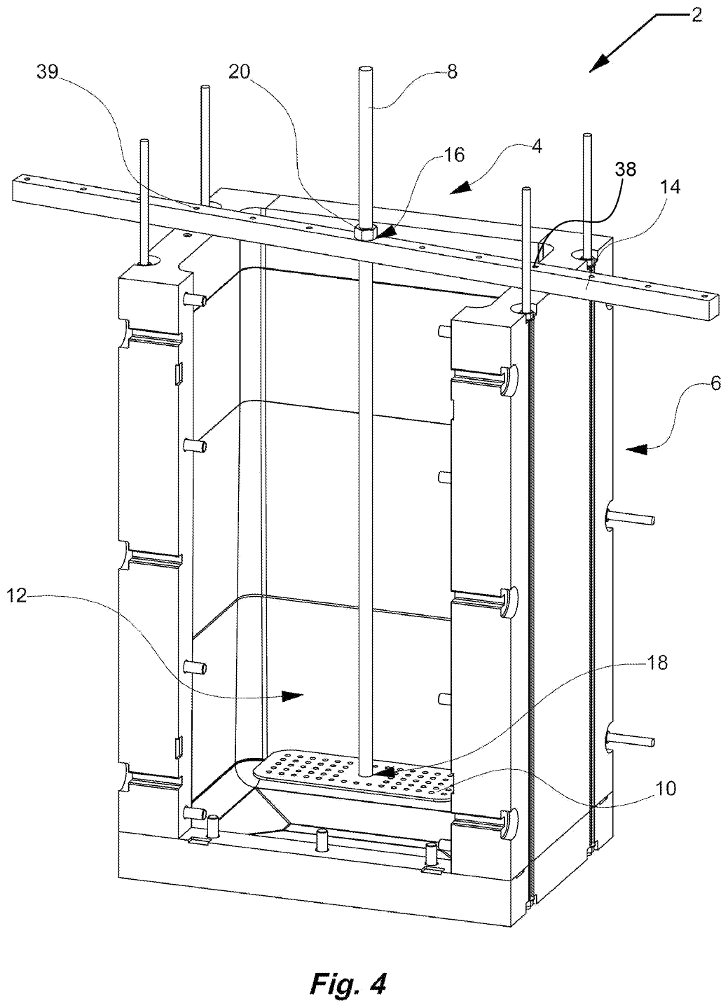

The mold 6 is preferably created (for example, machined) to facilitate high levels of precision, such as using a numerical control or computer numerical control (“CNC”) machining tool or a 3D printer. In some versions, the inner surfaces of the mold 6 (for example, the surfaces of the mold 6 that define the plug body 40 as discussed below) are smoothed (for example, sanded) and optionally painted or sprayed with a hard coating (for example, paint or gelcoat). In some version, the smoothed inner surfaces are waxed (for example, waxed with a paste wax) to facilitate easy removal of the plug body 40 as discussed below. The mold 6 preferably has retention members 34, 36, such as pegs (see FIG. 1), that are configured to retain the hanger 4 in a fixed position relative to the mold 6. For example, as shown in FIG. 3, the suspension member may define openings 38, 39 that are configured to receive the pegs. FIG. 4 shows the hanger 4 disposed in the mold 6 with a portion of the mold 6 removed to facilitate describing the position of the plug core 12 in the mold 6 and describing the interior of the mold 6. When the hanger 4 is disposed in the mold, the suspension member 14 is preferably disposed at a position along the plug core 12 (for example, a vertical position defined by the suspender 20 and, as best seen in FIG. 3, a horizontal position defined by the openings 16, 38, 39) that spaces the plug core 12 apart from inner surfaces of the walls and floor of the mold 6. The inner surfaces of the mold 6 are preferably sized and dimensioned to define the outer size and shape of a plug body to be made with the system 2. Accordingly, with the plug core 12 suspended in the mold 6 (while fully assembled as shown in FIG. 3), uncured elastomeric material, such as rubber (for example, silicone, urethane or polyurethane materials, such as platinum-cure silicone), is preferably poured into the mold 6 and allowed to cure. In other embodiments, the uncured elastomeric material is poured into the mold, and the plug core 12 is subsequently inserted into and suspended in the mold 6 before the elastomeric material cures.

After the elastomeric material cures or at least partially cures, the plug core 12 is preferably removed from the mold 6 with the cured elastomeric material disposed on the plug core 12. As shown in FIGS. 3 and 4, the mold 6 is preferably modular, for example enabling the walls and bottom of the mold 6 to be separated from each other. Accordingly, the plug core 12 and the cured elastomeric material are preferably lifted out of the mold 6, and in versions with mild undercuts, the cured elastomeric material preferably resiliently deforms to facilitate such removal, or in versions with severe undercuts, the mold 6 is preferably at least partially disassembled to enable removing the plug core 12 and the cured elastomeric material.

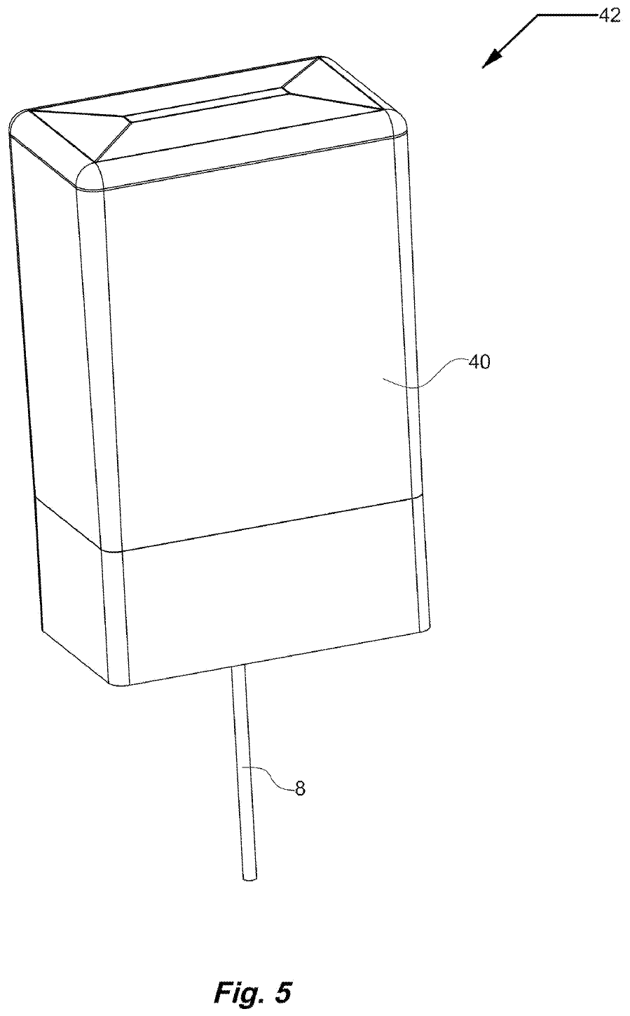

As shown in FIG. 5, the cured elastomeric material preferably defines a plug body 40 that has an outer size and shape that matches or is the same as the inner size and shape of the mold 6. The plug core 12 is preferably configured to couple the plug body 40 to a press (not shown). For example, a portion of the plug core 12 such as the rod 8 preferably protrudes from the plug body 40 and may be clamped or otherwise secured to a hydraulic press (not shown). The shore hardness of the plug body 40 is preferably between 55 A and 75 A, such as 60 A, 65 A or 70 A. Accordingly, the plug core 12 and the plug body 40 preferably define an elastomeric plug 42. In alternative embodiments, the plug core 12 is omitted, and a press (not shown) directly couples to the plug body 40 instead of the plug core 12.

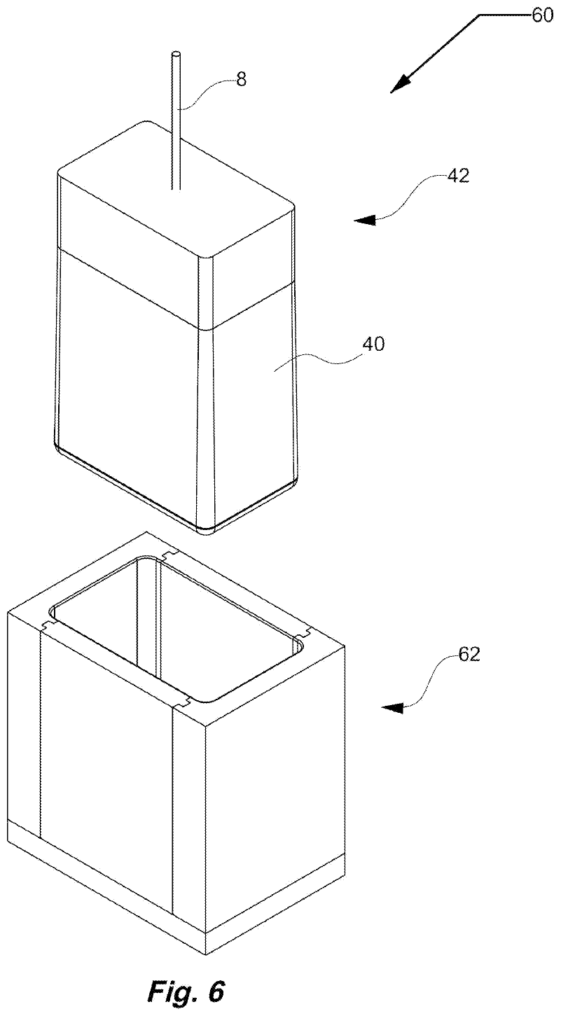

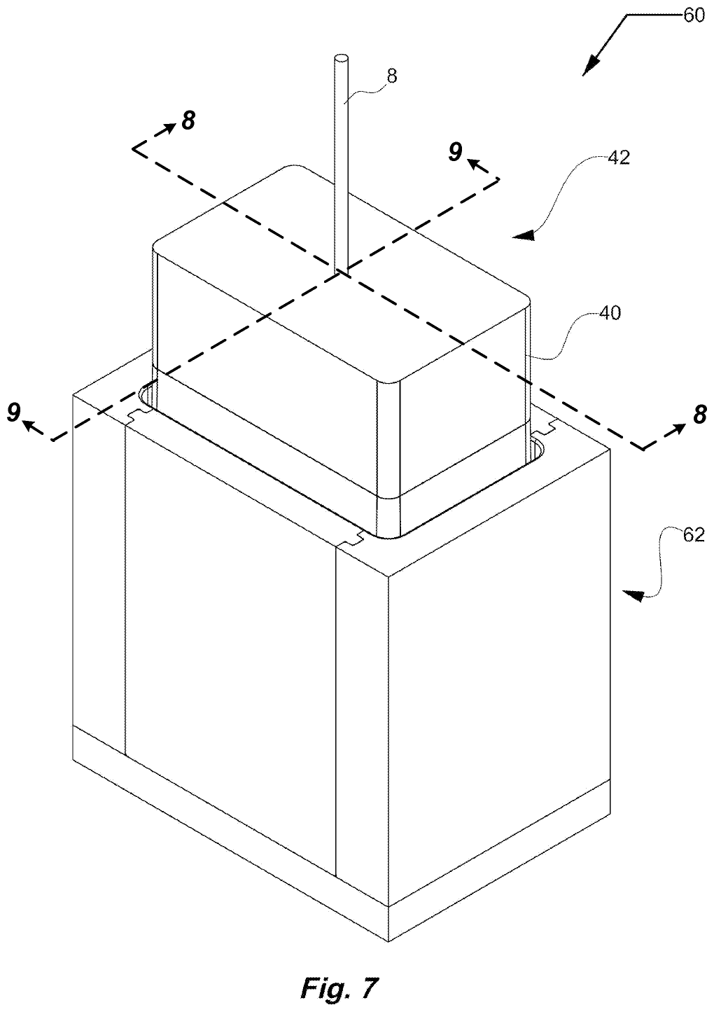

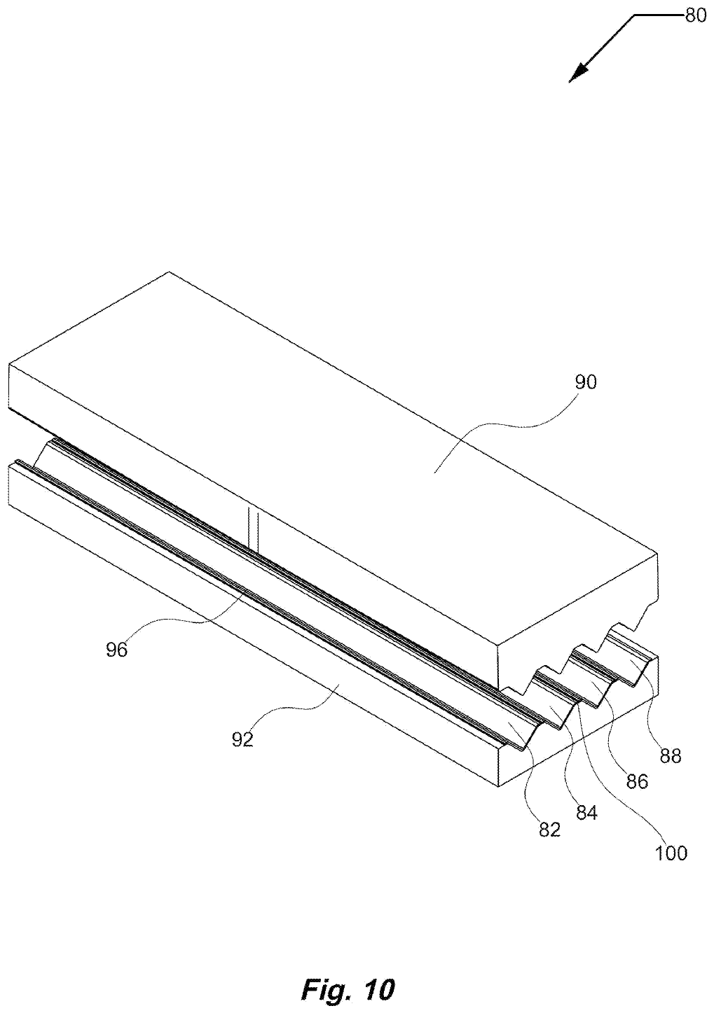

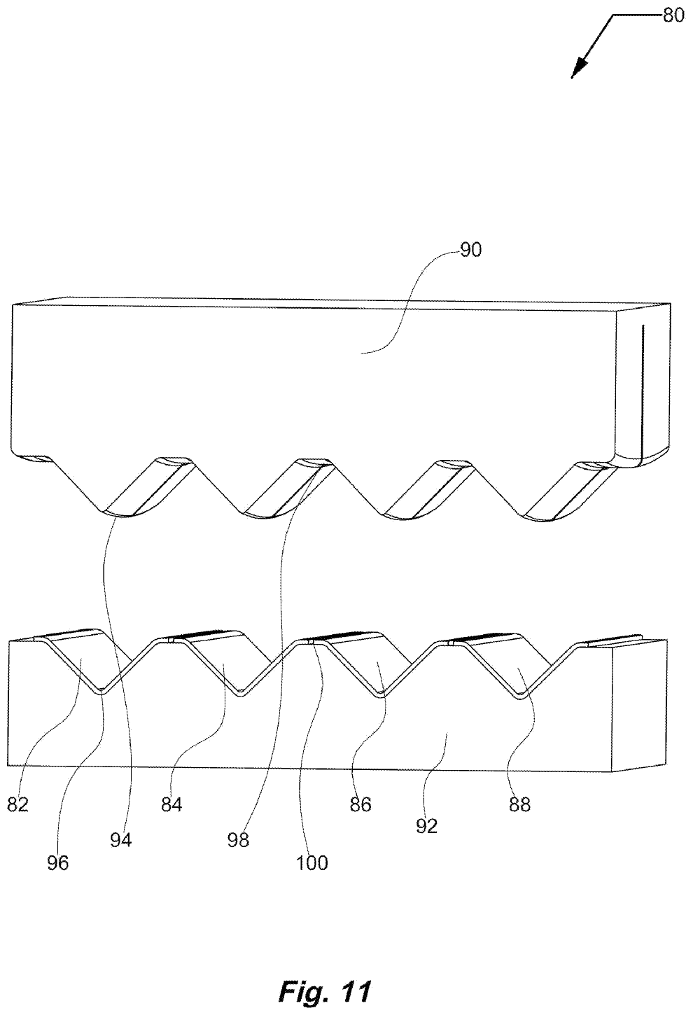

FIG. 6 shows a system 60 for compression molding a product, including the plug 42 and a mold 62. The plug 42 is preferably coupled to a press (not shown) and positioned over the mold 62. Polymeric material (not shown), for example in the form of reinforcement fabric with thermoset resin, is preferably placed into the mold 62. The mold 62 itself may be heated. The plug 42 is preferably then lowered into the mold 62 as shown in FIG. 7 and force applied by the press to compress the polymeric material or resin between the plug 42 and the mold 62 to form a product (not shown; see FIGS. 10 and 11).

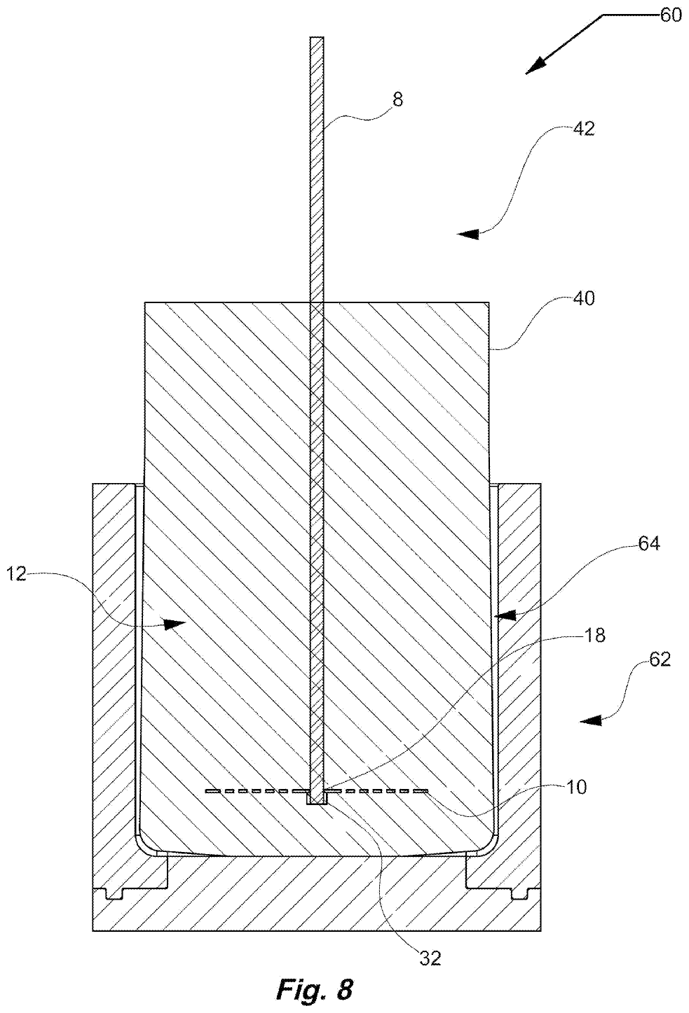

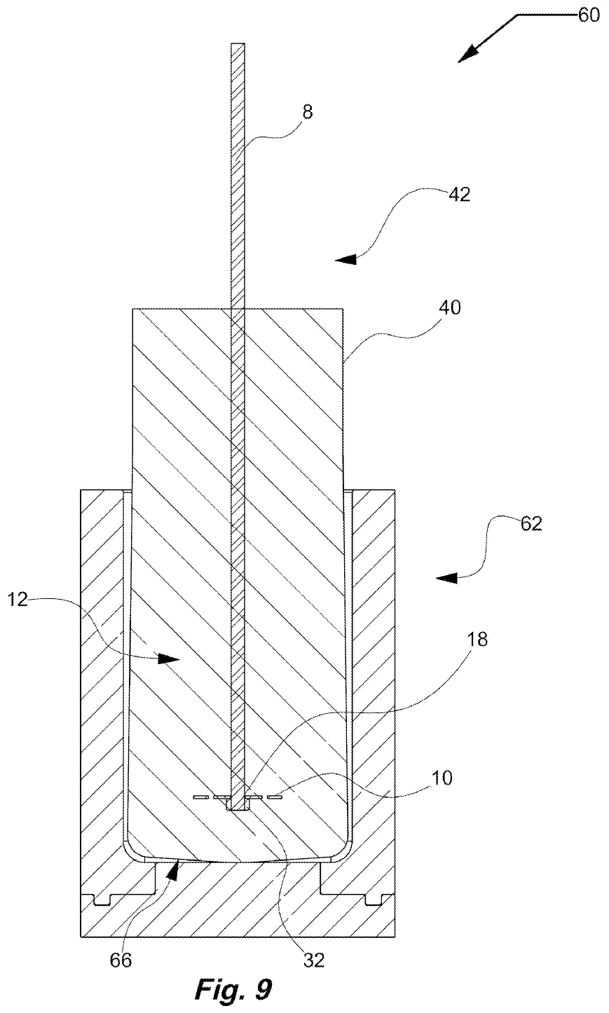

As shown in the cross-sectional views of FIGS. 8 and 9, the outer shape of the plug body 40 is preferably mismatched with respect to or different than the inner shape of the mold 62 and, most preferably, mismatched with respect to the shape of the product to be manufactured because the elastomeric plug body 40 is configured to deform in at least one region that contacts the polymeric material or resin to define a portion of the manufactured product. For example, the upright surfaces of the plug body 40 may define drafts, such as draft 64 (see FIG. 8), while the walls of the mold 62 are non-drafted, making the upright surfaces of the plug body 40 transverse to the walls of the mold 62. Note that a product shaped in this manner forms an undercut that could not be removed from a metal plug, but the elastomeric plug body 40 is configured to resiliently deform to facilitate removal of the product. Using silicone for the plug body 40 also facilitates easier removal of the product because of the release properties of silicone.

As another example, the bottom of the plug body 40 may define a crown or a dome 66 (see FIG. 9) while the inner surface of the bottom of the mold 62 is flat or substantially flat. Different combinations of shapes or features in the plug body 40 are preferably configured to provide different control of flow of the heated polymeric material or resin in the mold 62. For example, the combination of the dome 66 and radiused bottom edges of the plug body 40 is preferably configured to move the resin under pressure up to the space between the non-drafted walls of the mold 62 and the drafted surfaces of the plug body 40, enabling the plug body 40 to apply pressure to the manufactured product against the non-drafted walls of the mold 62. Other plug shapes may be configured to prevent movement of the resin. In some versions, the plug body 40 includes a combination of shapes that is configured to cause resin to flow in some areas of the manufactured part and another combination of shapes that is configured to prevent flow of the resin in other areas of the manufactured part. For example, the plug body 40 may define grooves that guide excess resin out of the mold to provide improved consistency of manufactured products and may include divots and ridges to control flash and prevent the resin from flowing beyond those flash regions in the mold. An example use of such configuration is creating multiple manufactured products side by side in one mold with one plug without the flash of such products contacting each other. In some versions, the plug body 40 may be shaped to move resin into or away from critical areas. In some versions, the plug body 40 may be shaped to create areas of increased pressure, decreased pressure or no pressure. For example, the plug body 40 may be configured to apply higher pressure at edges or corners of the manufactured product. Other examples of plug-body shapes include varying radius edges, such as a radiused edge that has a 1 inch radius at the bottom portion of the edge curve, a 0.75 inch radius at the top portion of the edge curve, and a smooth transition therebetween.

FIGS. 1-9 show systems for manufacturing box-type products. The methods and systems described herein may also be configured to manufacture non-box-type products. FIGS. 10 and 11 show a portion of a system 80 for compression molding non-box-type products, such as the products 82, 84, 86, 88. The system 80 includes an elastomeric plug 90 (only a portion shown) made in accordance with the principals described herein and a compression mold 92 (only a portion shown). The non-box-type products 82-88 have been manufactured by compression molding using the plug 90 and the mold 92 in accordance with the principals described herein. As shown in FIG. 11, portions of the plug 90 that define corresponding portions of the products 82-88 have shapes that are mismatched with respect to or different than the shapes of those corresponding portions of the products 82-88. For example, the plug 90 defines domed ridges, such as the domed ridge 94, that have elevational curves along their lengths, whereas the corresponding portions of the products 82-88, such as the valley 96, are devoid of elevational curves along their lengths because the elastomeric plug 90 deforms under compression. As another example, the ridges of the plug 90 are separated by domed grooves, such as the domed groove 98, whereas the corresponding portions of the products 82-88, such as the plateau 100, are devoid of elevational curves along their lengths because the elastomeric plug 90 deforms under compression. In both of these examples, the domed shapes are configured to guide the resin from the middle outward along the lengths of the products 82-88 toward the edges of the manufactured product.

The methods described herein facilitate making plugs in a few hours, compared to multiple days or weeks for hand grinding, and with manufacturing the precision of match-metal compression but with increased control over resin flow during compression. The plug body is preferably formed as a unitary body that is devoid of glued seams, thereby providing improved durability over known rubber plugs. Moreover, undercuts may be overcome due to the resilient characteristics of the elastomeric plug made with elastomeric materials such as those described herein. Accordingly, the methods described herein provide the advantages of match-metal compression molding but with improved capability for manufacturing products with complex shapes.

As used herein, the following terms take the meanings explicitly associated herein, unless the context clearly dictates otherwise. The term “or” is an inclusive grammatical conjunction to indicate that one or more of the connected terms may be employed. For example, the phrase “one or more A, B or C” or the phrase “one or more As, Bs or Cs” is employed to discretely disclose each of the following: i) one or more As, ii) one or more Bs, iii) one or more Cs, iv) one or more As and one or more Bs, v) one or more As and one or more Cs, vi) one or more Bs and one or more Cs and vii) one or more As, one or more Bs and one or more Cs. The term “based on” as used herein is not exclusive and allows for being based on additional factors not described. The articles “a,” “an,” and “the” include plural references. Plural references are intended to also disclose the singular. The term “one or more” discloses no more than a single one or more than one, up to and including all.

The term “upright” refers to a dimension that is substantially parallel to the direction that the plug moves into and out of the female compression mold (i.e., the direction of pull) to orient the reader and does not limit the orientation of the plug or mold such that the plug moves vertically into and out of the compression mold. The term “transverse” refers to a non-parallel orientation and includes but is not limited to a perpendicular orientation.

The term “configured” refers to an element being one or more of sized, dimensioned, positioned or oriented to achieve or provide the recited function or result.

The term “approximately” refers to the described value or a range of values that include all values within 5, 10, 20, 30, 40 or 50 percent of the described value. All values described herein are intended to disclose those precise values and to also disclose approximately those values. The term “substantially parallel” refers to parallel or within 5, 10, 15, 20, 25, 30, 35, 40 or 45 degrees of parallel. The term “directly coupled” refers to a component that contacts (for example, when bolted) or is welded to another component. The term “indirectly coupled” refers to a component that is coupled to one or more other components that are coupled to a second component or one or more further components that are coupled to the second component. The term “coupled” should be understood to disclose both direct and indirect coupling of components or elements that are described as being coupled to each other.

While the preferred embodiment of the invention has been illustrated and described, as noted above, many changes can be made without departing from the spirit and scope of the invention. For example, each disclosure of an element or component preferably having a feature or characteristic is intended to also disclose the element or component as being devoid of that feature or characteristic, unless the principles of the invention clearly dictate otherwise. Accordingly, the scope of the invention is not limited by the disclosure of the preferred embodiments. Instead, the invention should be determined entirely by reference to the claims that follow. Moreover, each feature, characteristic, element or component described herein may be implemented in combination with one or more other features, characteristics, elements or components described herein. It should also be noted that the claim dependencies or combinations of elements recited in the claims does not reflect an intention to forgo claiming other subject matter disclosed herein. Instead, this disclosure is intended to also disclose the subject matter of any combination of any two or more of the claims, such that subsequent claim sets may recite that any one of the dependent claims depends from any other one or more claims, up to and including all other claims in the alternative (for example, “The method of any one of the preceding or subsequent claims . . . ”). This disclosure is also intended to disclose the subject matter of any one of the dependent claims, as if it was an independent claim, with or without all or a portion of the subject matter of the original independent claim(s) or any other subject matter disclosed herein.

1. A method for compression molding a polymeric product, the method comprising:
creating a casting mold;
placing elastomeric material in the casting mold;
allowing the elastomeric material to at least partially cure in the casting mold to define a plug body;
removing the plug body from the casting mold;
providing a female compression mold;
placing polymeric material in the female compression mold; and
compressing the polymeric material in the female compression mold with the plug body to compression mold a polymeric product.

2. The method of claim 1, further comprising suspending a plug core in the casting mold before the elastomeric material cures.

3. The method of claim 2, further comprising coupling the plug core to a press, wherein compressing the polymeric material in the female compression mold with the plug body includes compressing the polymeric material under a force applied by the press through the plug body.

4. The method of claim 1, wherein the plug body has a first surface that contacts a second surface of the polymeric product when compressing the polymeric material, and a shape of the first surface before compressing the polymeric material is different than a shape of the second surface of the polymeric product after compressing the polymeric material.

5. The method of claim 4, wherein the plug body has a shape that is configured to move polymeric material out of the compression mold.

6. The method of claim 4, wherein the plug body has a shape that is configured to prevent polymeric material from flowing beyond a flash region in the mold.

7. The method of claim 1, wherein the plug body has drafted upright walls, and the female compression mold has non-drafted upright walls.

8. The method of claim 1, wherein the plug body is configured to apply pressure to non-drafted upright walls in the female compression mold.

9. The method of claim 1, wherein the plug body has a shore hardness between approximately 55 A and 75 A.

10. The method of claim 1, wherein the plug body has a shore hardness of approximately 60 A.

11. The method of claim 1, wherein the polymeric material is a composite material, and the polymeric product is a composite product.

12. The method of claim 1, wherein the elastomeric material includes platinum-cure silicone.

13. The method of claim 1, wherein creating the casting mold includes programming a numeric control or computer numeric control (“CNC”) machining tool to machine the casting mold.

14. The method of claim 1, wherein creating the casting mold includes printing the casting mold with a 3D printer.

15. A system for compression molding a polymeric product, the system comprising:
a plug core; and
a cast elastomeric plug body coupled to the plug core, the elastomeric plug body being resiliently deformable between a non-compressed state and a compressed state, the elastomeric plug body having a first surface that contacts a second surface of the polymeric product when compression molding the polymeric product, a shape of the first surface in the non-compressed state being different than a shape of the second surface after compression-molding the polymeric product.

16. The plug of claim 15, wherein the plug body is configured to apply pressure to non-drafted upright walls of the polymeric product when compression molding the polymeric product.

17. The system of claim 15, further comprising a female compression mold, wherein the plug body has drafted upright walls, and the female compression mold has non-drafted upright walls.
